(19) United States
(12) Patent Application Publication
(10) Pub. No.: US 2013/0040210 A1
(43) Pub. Date: Feb. 14, 2013

(54) NONAQUEOUS ELECTROLYTE AND METAL AIR BATTERY

(71) Applicants: Fuminori Mizuno, Toyota-shi (JP); Hidetaka Nishikori, Toyota-shi (JP); Hirofumi Nakamoto, Toyota-shi (JP)

(72) Inventors: Fuminori Mizuno, Toyota-shi (JP); Hidetaka Nishikori, Toyota-shi (JP); Hirofumi Nakamoto, Toyota-shi (JP)

(73) Assignee: TOYOTA JIDOSHA KABUSHIKI KAISHA, Toyota-shi, Aichi (JP)

(21) Appl. No.: 13/321,986

(22) PCT Filed: Mar. 10, 2010
(86) PCT No.: PCT/JP2010/053995

§ 371 Date: Nov. 22, 2011

(51) Int. Cl. H01M 8/22

(52) U.S. Cl. 429/405; 429/403

(57) ABSTRACT

The main object of the present invention is to provide a nonaqueous electrolyte having favorable radical resistance. The present invention attains the object by providing a nonaqueous electrolyte comprising an ionic liquid having a cation portion and an anion portion, an organic solvent, and a metal salt, characterized in that the maximum electric charge calculated by the first-principle calculation in the cation portion of the ionic liquid and the organic solvent is 0.3 or less.

### TECHNICAL FIELD

The present invention relates to a nonaqueous electrolyte having favorable radical resistance.

### BACKGROUND ART

A metal air battery is a nonaqueous battery using air (oxygen) as a cathode active material, and has the advantages that energy density is high and downsizing and weight saving are easy. Thus, a metal air battery has been presently noted as a higher-capacity battery than a widely used lithium battery.

Such a metal air battery, for example, has an air cathode layer having a conductive material (such as carbon black), a catalyst (such as manganese dioxide) and a binder (such as polyvinylidene fluoride), an air cathode current collector for performing current collecting of the air cathode layer, an anode layer containing an anode active material (such as metal Li), an anode current collector for performing current collecting of the anode layer, and a nonaqueous electrolyte (such as a nonaqueous liquid electrolyte).

Conventionally, a metal salt (such as LiPF₆) is dissolved in organic solvents such as ethylene carbonate (EC), propylene carbonate (PC), dimethyl carbonate (DMC) and diethyl carbonate (DEC) has been used for a nonaqueous electrolyte of a metal air battery. On the other hand, when a metal air battery is produced by using such a nonaqueous electrolyte, there exists a problem that the nonaqueous electrolyte volatilizes from an air hole provided for a case of the metal air battery. It is known that an ionic liquid with high nonvolatility is used as a nonaqueous electrolyte for such a problem.

For example, it is disclosed in Patent Literature 1 that an ordinary temperature molten salt (ionic liquid) having a specific structure is used for a nonaqueous electrolyte of a nonaqueous electrolyte air battery. This technique is intended for improving discharge capacity under a high-temperature environment by using an ordinary temperature molten salt with high nonvolatility.

### CITATION LIST

### Patent Literature

Patent Literature 1: Japanese Patent Publication No. 4,015,916

### SUMMARY OF INVENTION

### Technical Problem

In the case of using an ionic liquid for a nonaqueous electrolyte of a metal air battery, though preferable in nonvolatility, it is assumed that the ionic liquid is deteriorated (decomposed) due to a radical produced in an electrode reaction (such as an oxygen radical). Further, in a nonaqueous electrolyte battery except a metal air battery, for example, it is assumed that an ionic liquid is decomposed due to the production of a radical derived from oxygen which mixed in during a production process, and the like.

The present invention has been made in view of the above-mentioned actual circumstances, and the main object thereof is to provide a nonaqueous electrolyte having favorable radical resistance.

### Solution to Problem

In order to achieve the above-mentioned object, the present invention provides a nonaqueous electrolyte comprising an ionic liquid having a cation portion and an anion portion, an organic solvent, and a metal salt, characterized in that a maximum electric charge calculated by a first-principle calculation in the cation portion of the above-mentioned ionic liquid and the above-mentioned organic solvent is 0.3 or less.

The present invention provides a nonaqueous electrolyte having favorable radical resistance for the reason that the maximum electric charge of the cation portion of the ionic liquid and the organic solvent is in a specific range. Thus, a nonaqueous electrolyte may be restrained from deteriorating (decomposing) due to a radical.

In the above-mentioned present invention, the viscosity is preferably 100 mPa·s or less. The reason therefor is that the operation of a battery in a high current density range is facilitated.

In the above-mentioned present invention, the above-mentioned ionic liquid is preferably N-methyl-N-propylpiperidiniumbistrifluoromethanesulfonylimide. The reason therefor is to be excellent in radical resistance.

In the above-mentioned present invention, the above-mentioned organic solvent is preferably at least one of acetonitrile and dimethoxyethane. The reason therefor is to be excellent in radical resistance.

In the above-mentioned present invention, the ratio of the above-mentioned organic solvent to the total of the above-mentioned ionic liquid and the above-mentioned organic solvent is preferably within a range of 1% by volume to 50% by volume. The reason therefor is that the above-mentioned range allows a nonaqueous electrolyte with low viscosity while maintaining the desired nonvolatility.

In the above-mentioned present invention, a nonaqueous electrolyte is preferably used for a metal air battery. The reason therefor is that an oxygen radical is produced by an electrode reaction during the charge and discharge to cause the deterioration of a nonaqueous electrolyte so easily as to easily perform the effect of the present invention.

Further, the present invention provides a metal air battery comprising an air cathode having an air cathode layer containing a conductive material and an air cathode current collector for performing current collecting of the above-mentioned air cathode layer, an anode having an anode layer containing an anode active material and an anode current collector for performing current collecting of the above-mentioned anode layer, and a nonaqueous electrolyte for performing conduction of a metal ion between the above-mentioned air cathode layer and the above-mentioned anode layer, characterized in that the above-mentioned nonaqueous electrolyte is the nonaqueous electrolyte described above.

According to the present invention, the use of the nonaqueous electrolyte described above may restrain the deterioration due to a radical to allow a metal air battery excellent an durability.

### Advantageous Effects of Invention

The present invention brings the effect that a nonaqueous electrolyte having favorable radical resistance may be obtained.

### BRIEF DESCRIPTION OF DRAWINGS

FIG. 1 is a schematic cross-sectional view showing an example of a metal air battery of the present invention.

FIG. 2 is a result of a charge-discharge test of an evaluation cell using a nonaqueous electrolyte obtained in Production Example 1.

FIG. 3 is a result of measuring viscosity of mixed solvents obtained in Production Examples 1 to 5 and comparison samples obtained in Comparative Production Examples 1 and 2.

### DESCRIPTION OF EMBODIMENTS

A nonaqueous electrolyte and a metal air battery of the present invention are hereinafter described in detail.

### A. Nonaqueous Electrolyte

First, a nonaqueous electrolyte of the present invention is described. The nonaqueous electrolyte of the present invention comprises an ionic liquid having a cation portion and an anion portion, an organic solvent, and a metal salt, characterized in that the maximum electric charge calculated by the first-principle calculation in the cation portion of the above-mentioned ionic liquid and the above-mentioned organic solvent is 0.3 or less.

The present invention provides a nonaqueous electrolyte having favorable radical resistance for the reason that the maximum electric charge of the cation portion of the ionic liquid and the organic solvent is in a specific range. Thus, a nonaqueous electrolyte may be restrained from deteriorating (decomposing) due to a radical. In particular, in an Li air battery, an oxygen radical is produced by an electrode reaction during the charge and discharge to thereby cause the deterioration of a nonaqueous electrolyte easily. A Li oxide (Li₂O) and an Li peroxide (Li₂O₂) as discharge products in an Li air battery are also factors in deteriorating a nonaqueous electrolyte. On the contrary, in the present invention, the deterioration due to an oxygen radical, Li₂O and Li₂O₂ may be prevented for the reason that the maximum electric charge of the cation portion of the ionic liquid and the organic solvent is in a specific range. In addition, it is conceived that the ionic liquid is generally so high in viscosity that battery resistance becomes high and the operation of a battery in a high current density range becomes difficult; however, in the present invention, the addition of the organic solvent which is generally low in viscosity as compared with the ionic liquid may adjust the viscosity of the ionic liquid to a desired range to allow a nonaqueous electrolyte excellent in properties of a high current density range.

Next, the maximum electric charge in the present invention is described. The present invention is greatly characterized in that the cation portion of the ionic liquid and the organic solvent have the specific maximum electric charge calculated by the first-principle calculation. An element (a region) having the maximum electric charge may become a site (a starting point) attacked by an oxygen radical, so that smaller value thereof brings higher stability against the radical. Here, the maximum electric charge is calculated in the following manner. With regard to the value of electric charge of each atom, one molecule is subject to structural optimization by Gaussian03 Rev. D with HF/6-311G** and the maximum electric charge may be calculated by performing one-point energy calculation with MP2/6-311G**.

In the present invention, the above-mentioned maximum electric charge in the cation portion of the ionic liquid is generally 0.3 or less and preferably 0.1 or less. Similarly, the above-mentioned maximum electric charge in the organic solvent is generally 0.3 or less and preferably 0.1 or less.

The nonaqueous electrolyte of the present invention is hereinafter described in each configuration.

### 1. Ionic Liquid

First, the ionic liquid in the present invention is described. The ionic liquid in the present invention has a cation portion and an anion portion. In addition, the above-mentioned cation portion is characterized in that the maximum electric charge calculated by the above-mentioned first-principle calculation is in a specific range. In the present invention, the ionic liquid having the cation portion may be used singly or in a mixture with two kinds or more. Further, the ionic liquid in the present invention is preferably liquid at ordinary temperature (25° C.).

The above-mentioned cation portion is not particularly limited if it has the predetermined maximum electric charge; examples thereof include N-methyl-N-propylpiperidinium (PP13⁺, the maximum electric charge: −0.132), N-methyl-N-propylpyrrolidinium (P13⁺, the maximum electric charge: −0.119), N-methyl-N-butylpyrrolidinium (P14⁺, the maximum electric charge: −0.115), N,N,N-trimethyl-N-butylammonium (TMBA⁺, the maximum electric charge: −0.134), N,N,N-trimethyl-N-hexylammonium (TMHA⁺, the maximum electric charge: −0.134), N-diethyl-N-methyl-N-propylammonium (DEMPA⁺, the maximum electric charge: −0.143), N-diethyl-N-methyl-N-isopropylammonium (DEMiPA⁺, the maximum electric charge: −0.139), and N,N-diethyl-N-methyl-N-(2-methoxyethyl)ammonium (DEME⁺, the maximum electric charge: 0.046).

On the other hand, the above-mentioned anion portion is not particularly limited if it allows the ionic liquid in combination with the above-mentioned cation portion; examples thereof include bistrifluoromethanesulfonylimide (TFSI⁻), trifluorosulfonate (TfO⁻), tetrafluoroboric acid (BF₄⁻) ion, and hexafluorophosphate (PF₆⁻) ion.

In particular, in the present invention, the ionic liquid is preferably N-methyl-N-propylpiperidiniumbistrifluoromethanesulfonylimi de (PP13TFSI), N-methyl-N-propylpyrrolidiniumbistrifluoromethanesulfonylimide (P13TFSI), N-methyl-N-butylpyrrolidiniumbistrifluoromethanesulfonylimide (P14TFSI), and N,N,N-trimethyl-N-propylammoniumbistrifluoromethanesulfonylimide (TMPATFSI).

Further, in the present invention, the addition of low-viscosity organic solvent to a high-viscosity ionic liquid allows a nonaqueous electrolyte with low viscosity. Thus, higher viscosity of a nonaqueous electrolyte brings greater effect of decreasing viscosity. The viscosity (25° C.) of the ionic liquid in the present invention is, for example, preferably 40 mPa·S or more, more preferably within a range of 40 mPa·s to 100 mPa·s, and far more preferably within a range of 40 mPa·s to 200 mPa·s. The viscosity of the ionic liquid may be measured by a commercially available viscometer.

### 2. Organic Solvent

Next, the organic solvent in the present invention is described. The organic solvent (nonaqueous solvent) in the present invention is characterized in that the maximum electric charge calculated by the above-mentioned first-principle calculation is in a specific range. In the present invention, the above-mentioned organic solvent may be used singly or in a mixture with two kinds or more.

The above-mentioned organic solvent is not particularly limited if it has the predetermined maximum electric charge; examples thereof include acetonitrile (AN, the maximum electric charge: 0.061), dimethoxyethane (DME, the maximum electric charge: 0.049), and tetrahydrofuran (THF, the maximum electric charge: 0.055).

The viscosity of the organic solvent is generally low and the value thereof is not particularly limited. The viscosity (25° C.) of the organic solvent in the present invention is, for example, preferably 10 mPa·S or less and more preferably 1 mPa·S or less.

### 3. Metal Salt

Next, the metal salt in the present invention is described. The nonaqueous electrolyte of the present invention generally contains the metal salt in addition to the above-mentioned ionic liquid and organic solvent. The metal salt in the present invention generally contains a metal ion which conducts between a cathode and an anode in a battery, and the kind of the metal salt varies depending on factors such as the usage of the nonaqueous electrolyte. Examples of a lithium salt containing an Li ion include inorganic lithium salts such as LiPF₆, LiBF₄, LiClO₄ and LiAsF₆; and organic lithium salts such as LiCF₃SO₃, LiN(CF₃SO₂)₂, LiN(C₂F₅SO₂)₂ and LiC(CF₃SO₂)₃. The concentration of the metal salt in the nonaqueous electrolyte is not particularly limited and is preferably within a range of 0.5 mol/L to 3 mol/L, for example.

### 4. Nonaqueous Electrolyte

The nonaqueous electrolyte of the present invention may comprise only the ionic liquid and the organic solvent, or further comprise other compounds (such as the metal salt). Further, the nonaqueous electrolyte of the present invention is preferably liquid at ordinary temperature (25° C.). In addition, the nonaqueous electrolyte of the present invention is preferably low in viscosity. The reason therefor is that the production of a battery by using the nonaqueous electrolyte with low viscosity decreases battery resistance to facilitate the operation of a battery in a high current density range. The nonaqueous electrolyte with low viscosity is particularly useful for an on-vehicle battery whose operation is required in a high current density range. The viscosity (25° C.) of the nonaqueous electrolyte of the present invention is, for example, preferably 100 mPa·S or less, more preferably 75 mPa·S or less, and far more preferably 50 mPa·S or less.

The ratio of the ionic liquid and the organic solvent in the present invention is not particularly limited and preferably determined so as to allow the desired viscosity. The ratio of the organic solvent to the total of the ionic liquid and the organic solvent is for example, preferably within a range of 1% by volume to 50% by volume and within a range of 1% by volume to 20% by volume, above all. The reason therefor is that the above-mentioned range allows the nonaqueous electrolyte with low viscosity while maintaining the desired nonvolatlity.

In the present invention, it is preferable that the ionic liquid is N-methyl-N-propylpiperidiniumbistrifluoromethanesulfonylimi de (PP13TFSI) and the organic solvent is at least one of acetonitrile (AN) and dimethoxyethane (DME). The reason therefor is that the addition of at least one of AN and DME to PP13TFSI allows the viscosity to be remarkably decreased.

The use of the nonaqueous electrolyte of the present invention is not particularly limited and may be used for a nonaqueous electrolyte battery, for example. It is assumed that oxygen mixes into the battery during the production process of a nonaqueous electrolyte battery and a radical derived from the oxygen, and the like are produced due to an electrode reaction, and the nonaqueous electrolyte may be prevented from deteriorating even in such a case. The above-mentioned nonaqueous electrolyte battery is not particularly limited if it is a battery using the nonaqueous electrolyte; examples thereof include a metal ion battery and a metal air battery. In particular, the nonaqueous electrolyte of the present invention is preferably used for a metal air battery. The reason therefor is that an oxygen radical, a metal oxide, a metal peroxide, and the like are produced due to an electrode reaction to easily cause the deterioration of a nonaqueous electrolyte.

The nonaqueous electrolyte of the present invention may be obtained by mixing the above-mentioned ionic liquid and organic solvent, for example.

### B. Metal Air Battery

Next, a metal air battery of the present invention is described. The metal air battery of the present invention comprises an air cathode having an air cathode layer containing a conductive material and an air cathode current collector for performing current collecting of the above-mentioned air cathode layer, an anode having an anode layer containing an anode active material and an anode current collector for performing current collecting of the above-mentioned anode layer, and a nonaqueous electrolyte for performing conduction of a metal ion between the above-mentioned air cathode layer and the above-mentioned anode layer, and characterized in that the above-mentioned nonaqueous electrolyte is the nonaqueous electrolyte described above.

According to the present invention, the use of the nonaqueous electrolyte described above may restrain the deterioration due to a radical to allow a metal air battery excellent in durability.

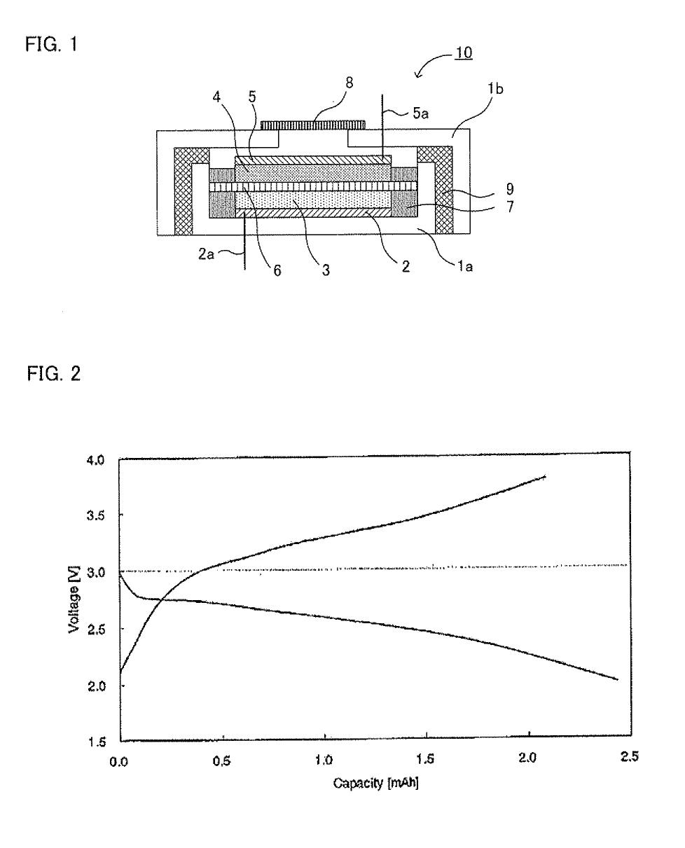

FIG. 1 is a schematic cross-sectional view showing an example of the metal air battery of the present invention. A metal air battery 10 shown in FIG. 1 comprises: an anode case 1a, an anode current collector 2 formed on the inside surface of the bottom of the anode case 1a, an anode lead 2a connected to the anode current collector 2, an anode layer 3 containing an anode active material (such as metal Li) and formed on the anode current collector 2, an air cathode layer 4 containing a conductive material (such as a carbon material), a catalyst (such as manganese dioxide) and a binder (such as polyvinylidene fluoride), an air cathode current collector 5 for performing current collecting of the air cathode layer 4, an air cathode lead 5a connected to the air cathode current collector 5, a separator 6 disposed between the anode layer 3 and the air cathode layer 4, a nonaqueous electrolyte 7 in which the anode layer 3 and the air cathode layer 4 are immersed, an air cathode case 1b having a microporous membrane 8 for providing oxygen, and a packing 9 formed between the anode case 1a and the air cathode case 1b. The present invention is greatly characterized in that the nonaqueous electrolyte 7 is the nonaqueous electrolyte described above.

The metal air battery of the present invention is hereinafter described in each configuration.

### 1. Nonaqueous Electrolyte

First, the nonaqueous electrolyte in the present invention is described. The nonaqueous electrolyte in the present invention performs conduction of a metal ion between the air cathode layer and the anode layer. The description about the nonaqueous electrolyte in the present invention is the same as the contents described in the above-mentioned “A. Nonaqueous electrolyte”, therefore, the description thereof is omitted herein.

The metal air battery of the present invention preferably has the separator between the air cathode layer and the anode layer. The reason therefor is to allow a metal air battery with high safety. Examples of the above-mentioned separator include porous membranes such as polyethylene and polypropylene; and nonwoven fabrics such as resin nonwoven fabric and glass fiber nonwoven fabric.

### 2. Air Cathode

Next, the air cathode in the present invention is described. The air cathode in the present invention has an air cathode layer containing a conductive material and an air cathode current collector for performing current collecting of the above-mentioned air cathode layer.

### (1) Air Cathode Layer

The air cathode layer used for the present invention contains at least a conductive material. In addition, the air cathode layer may contain at least one of a catalyst and a binder, as required.

Examples of the conductive material used for the air cathode layer include a carbon material. Examples of the carbon material include graphite, acetylene black, carbon nanotube, carbon fiber, and mesoporous carbon. The content of the conductive material in the air cathode layer is preferably, for example, within a range of 10% by weight to 99% by weight, and within a range of 20% by weight to 85% by weight, above all.

Further, the air cathode layer used for the present invention may contain a catalyst for accelerating a reaction. The reason therefor is that an electrode reaction is performed more smoothly. Above all, the conductive material preferably supports the catalyst. Examples of the above-mentioned catalyst include inorganic compounds such as manganese dioxide and cerium dioxide and organic compounds (organic complexes) such as cobalt phthalocyanine. The content of the catalyst in the air cathode layer is preferably, for example, within a range of 1% by weight to 90% by weight, and within a range of 5% by weight to 50% by weight, above all.

Further, the air cathode layer used for the present invention may contain a binder for fixing the conductive material. Examples of the binder include fluorine-based binders such as polyvinylidene fluoride (PVDF) and polytetrafluoroethylene (PTFE). Rubber such as SBR may be used as the binder. The content of the binder in the air cathode layer is preferably, for example, 40% by weight or less, and within a range of 1% by weight to 10% by weight, above all.

Further, the air cathode layer used for the present invention preferably has a porous structure. The reason therefor is to allow contact area between air and the conductive material to be enlarged. The thickness of the air cathode layer varies depending on factors such as the usage of the metal air battery; and is preferably, for example, within a range of 2 μm to 500 μm, and within a range of 5 μm to 300 μm, above all.

### (2) Air Cathode Current Collector

The air cathode current collector used for the present invention performs current collecting of the air cathode layer. Examples of a material for the air cathode current collector include a metallic material and a carbon material, and above all, a carbon material is preferable. The reason therefor is that the carbon material has the advantages of being excellent in corrosion resistance, being excellent in electronic conductivity and being so light as compared with a metal that energy density per weight is increased. Examples of such a carbon material include carbon fiber, and activated carbon (such that a carbon plate is activated), and above all, carbon fiber is preferable. On the other hand, examples of the metallic material include stainless steel, nickel, aluminum, and titanium.

The structure of the air cathode current collector in the present invention is not particularly limited if the desired electronic conductivity may be secured, and may be a porous structure having gas diffusivity or a compact structure having no gas diffusivity. Above all, in the present invention, the air cathode current collector preferably has a porous structure having gas diffusivity. The reason therefor is to allow diffusion of oxygen to be promptly performed.

The thickness of the air cathode current collector in the present invention is preferably, for example, within a range of 10 μm to 1000 μm, and above all, within a range of 20 μm to 400 μm. In the present invention, the after-mentioned battery case may also have the function of the air cathode current collector.

### 3. Anode

Next, the anode in the present invention is described. The anode in the present invention has an anode layer containing an anode active material and an anode current collector for performing current collecting of the above-mentioned anode layer.

### (1) Anode Layer

The anode active material used for the present invention generally contains a metal, and specific examples thereof include elemental metals, alloys, metallic oxides, and metallic nitrides. In addition, examples of alloys having lithium element include a lithium-aluminum alloy, a lithium-tin alloy, a lithium-lead alloy, and a lithium-silicon alloy. Examples of metallic oxides having lithium element include lithium-titanium oxide. Examples of metallic nitrides having lithium element include lithium-cobalt nitride, lithium-iron nitride, and lithium-manganese nitride.

The anode layer in the present invention may contain only the anode active material, or at least one of a conductive material and a binder in addition to the anode active material. For example, in the case where the anode active material is in the shape of foil, the anode layer containing only the anode active material is allowed. On the other hand, in the case where the anode active material is in the shape of powder, the anode layer having at least one of a conductive material and a binder is allowed. The description about a conductive material and a binder are the same as the contents described in the above-mentioned “1. Air cathode”, therefore, the description thereof is omitted herein.

### (2) Anode Current Collector

The anode current collector used for the present invention performs current collecting of the anode layer. Materials for the anode current collector are not particularly limited if it has electrical conductivity; and examples thereof include copper, stainless steel, and nickel. Examples of the shape of the above-mentioned anode current collector include foil, plate, and mesh (grid). In the present invention, the after-mentioned battery case may also have the function of the anode current collector.

### 4. Battery Case

Next, the battery case used for the present invention is described. The shape of the battery case used for the present invention is not particularly limited if it may accommodate the above-mentioned air cathode, anode and nonaqueous electrolyte; and specific examples thereof include coin type, flat board type, cylindrical type, and laminate type. The battery case may be a battery case of an air open type or a battery case of a closed type, and is preferably a battery case of an air open type. The battery case of an air open type is a battery case capable of contacting with the air as shown in the above-mentioned FIG. 1. On the other hand, in the case where the battery case is the battery case of a closed type, the battery case of a closed type is preferably provided with a supply pipe and a discharge pipe of gas (air). In this case, air supplied and discharged is preferably high in oxygen concentration, and more preferably is pure oxygen. It is preferable that oxygen concentration is raised during the discharge and oxygen concentration is lowered during the charge.

### 5. Metal Air Battery

The kind of a conducting metal ion in the metal air battery of the present invention is not particularly limited. Above all, the above-mentioned metal ion is preferably an alkali metal ion or an alkaline earth metal ion, and more preferably an alkali metal ion. Examples of the above-mentioned alkali metal ion include an Li ion, an Na ion, and a K ion, and above all, an Li ion is preferable. The reason therefor is that a battery with high energy density may be obtained. Examples of the above-mentioned alkaline earth metal ion include an Mg ion, and a Ca ion. In the present invention, a Zn ion, an Al ion, and an Fe ion may be used as the above-mentioned metal ion.

The metal air battery of the present invention may be a primary battery or a secondary battery, and preferably be a secondary battery. Examples of usage of the metal air battery of the present invention include vehicle mounting use, stationary power source use, and domestic power source use. A method for producing the metal air battery of the present invention is not particularly limited but is the same as a general method for producing the metal air battery.

The present invention is not limited to the above-mentioned embodiments. The above-mentioned embodiments are examples, and any of the embodiments is included in the technical scope of the present invention if it has substantially the same constitution as the technical idea described in the claims of the present invention and produces the same function and effect.

### EXAMPLES

The present invention is described more specifically while referring to Production Examples hereinafter.

### Production Example 1

A mixed solvent was obtained by mixing N-methyl-N-propylpiperidiniumbistrifluoromethanesulfonylimi de (PP13TFSI) as an ionic liquid and acetonitrile (AN) as an organic solvent in an Ar atmosphere so as to obtain the volume ratio of PP13TESI:AN=98:2.

With regard to N-methyl-N-propylpiperidinium as a cation of PP13TFSI, when the maximum electric charge was calculated by the above-mentioned first-principle calculation, the value thereof was −0.132. On the other hand, with regard to AN, when the maximum electric charge was calculated by the above-mentioned first-principle calculation, the value thereof was 0.061.

### Production Examples 2 to 5

A mixed solvent was obtained in the same manner as in Production Example 1 except for modifying the volume ratio of PP13TFSI and AN into PP13TESI:AN=95:5 (Production Example 2), PP13TFSI:AN=90:10 (Production Example 3), PP13TFSI:AN=75:25 (Production Example 4), and PP13TFSI:AN=50:50 (Production Example 5), respectively.

### Comparative Production Example 11

PP13TFSI was prepared as a comparison sample.

### Comparative Production Example 2

AN was prepared as a comparison sample.

[Evaluations]

### (1) Charge-Discharge Cycle Test

A lithium air secondary battery was produced by using the mixed solvent obtained in Production Example 1. The assembling of the battery was performed in an argon box. A battery case of an electrochemical cell manufactured by HOKUTO DENKO CORPORATION was used.

First, metal Li (manufactured by Honjo Metal Co., Ltd., φ: 18 mm, thickness: 0.25 mm) was disposed in the battery case. Next, a separator (φ: 18 mm, thickness: 25 μm) made of polyethylene was disposed on the metal Li. Next, a nonaqueous electrolyte such that LiTFSI was dissolved in the above-mentioned mixed solvent at a concentration of 0.32 mol/kg was poured by 4.8 mL from above the separator. Next, a composition having 25 parts by weight of carbon black, 42 parts by weight of MnO₂ catalyst, 33 parts by weight of polyvinylidene fluoride (PVDF), and an acetone solvent, was applied on carbon paper (air cathode current collector, TCP-H-090™ manufactured by Toray Industries Inc., φ18 mm, thickness: 0.28 mm) with a doctor blade to form an air cathode layer (φ: 18 mm, weight per unit area: 5 mg). Next, the obtained air cathode layer of an air cathode was disposed and sealed so as to be opposed to the separator to obtain an evaluation cell.

Next, the obtained evaluation cell was disposed in a desiccator (oxygen concentration: 99.99% by volume, internal pressure: 1 atm, desiccator capacity: 1 L) filled with oxygen. Next, a charge-discharge cycle test was performed on the following conditions. The charge and discharge were started from discharge and performed under an environment of 25° C.

Discharge conditions: to perform discharge at an electric current of 0.05 mA/cm² until battery voltage reaches 2.0 V

Charge conditions: to perform charge at an electric current of 0.05 mA/cm² until battery voltage reaches 3.85 V

The obtained result of the charge-discharge cycle test is shown in FIG. 2. As shown in FIG. 2, it was confirmed that the case of using the mixed solvent obtained in Production Example 1 offered favorable charge-discharge properties.

### (2) Viscosity

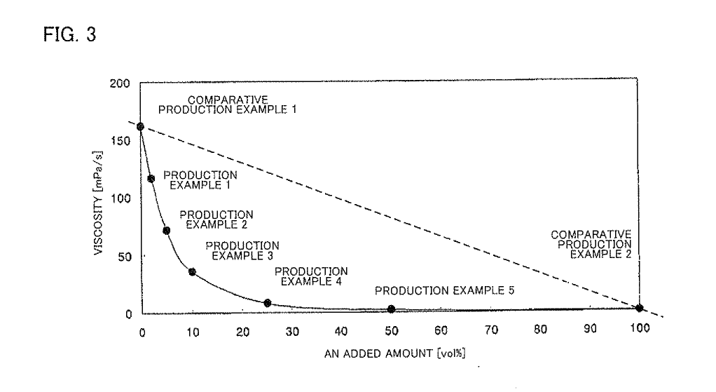

The viscosity (25° C.) was measured by using the mixed solvents obtained in Production Examples 1 to 5 and comparison samples obtained in Comparative Production Examples 1 and 2. The measurement of the viscosity was performed in an Ar glove box and the moisture amount of the objects to be measured was determined at 30 ppm or less. The result is shown in FIG. 3 and Table 1.

TABLE 1

| | AN added amount | Viscosity |
|---|---|---|
| | (vol %) | (mPa · s) |
| Comparative Production Example 1 | 0 | 161 |
| Production Example 1 | 2 | 116 |
| Production Example 2 | 5 | 71 |
| Production Example 3 | 10 | 35 |
| Production Example 4 | 25 | 8 |
| Production Example 5 | 50 | 2 |
| Comparative Production Example 2 | 100 | 0.4 |

As shown in FIG. 3, the viscosity decreased remarkably in Production Examples 1 to 5 as compared with Comparative Production Example 1. It was confirmed that the decrease of the viscosity was caused remarkably even though a small amount of AN was added. In particular, it was confirmed that the viscosity in Production Example 2 became approximately half of the viscosity in Comparative Production Example 1 and the viscosity in Production Example 4 became equal to the viscosity in AN.

### REFERENCE SIGNS LIST

1a anode case
1b air cathode case
2 anode current collector
2a anode lead
3 anode layer
4 air cathode layer
5 air cathode current collector
5a air cathode lead
6 separator
7 nonaqueous electrolyte
8 microporous membrane
9 packing

1-7. (canceled)

8. A nonaqueous electrolyte, comprising an ionic liquid having a cation portion and an anion portion, an organic solvent, and a metal salt; wherein a maximum electric charge calculated by a first-principle calculation in the cation portion of the ionic liquid and the organic solvent is 0.3 or less.

9. The nonaqueous electrolyte according to claim 8, wherein viscosity is 100 mPa·s or less.

10. The nonaqueous electrolyte according to claim 8, wherein the ionic liquid is N-methyl-N-propylpiperidiniumbistrifluoromethanesulfonylimide.

11. The nonaqueous electrolyte according to claim 8, wherein the organic solvent is at least one of acetonitrile and dimethoxyethane.

12. The nonaqueous electrolyte according to a claim 8, wherein a ratio of the organic solvent to a total of the ionic liquid and the organic solvent is within a range of 1% by volume to 50% by volume.

13. The nonaqueous electrolyte according to claim 8, wherein the nonaqueous electrolyte is used for a metal air battery.

14. A metal air battery, comprising:
an air cathode having an air cathode layer containing a conductive material and an air cathode current collector for performing current collecting of the air cathode layer,
an anode having an anode layer containing an anode active material and an anode current collector for performing current collecting of the anode layer, and
a nonaqueous electrolyte for performing conduction of a metal ion between the air cathode layer and the anode layer;
wherein the nonaqueous electrolyte is the nonaqueous electrolyte according to claim 8.
